(19) United States
(12) Patent Application Publication
(10) Pub. No.: US 2006/0196729 A1
(43) Pub. Date: Sep. 7, 2006

(54) Energy generating mechanism

(76) Inventor: Chin-Ho Chiu, Sansia Township (TW)

Correspondence Address: LOWE HAUPTMAN BERNER, LLP, 1700 DIAGONAL ROAD, SUITE 300, ALEXANDRIA, VA, 22314, US

(21) Appl. No.: 11/042,190

(22) Filed: Jan. 26, 2005

(51) Int. Cl. F03G 3/00

(52) U.S. Cl. 185/27

(57) ABSTRACT

An energy generating mechanism includes an energy generating device that has a solid frame with a lever received therein. Two cases are respectively and movably connected to two ends of the lever and each of the two cases has respective one of two boxes and each of the two boxes has an adjusting member which changes an arm of force of the lever so that the lever is controlled to swing up and down consistently. An energy collection device is connected to the energy generating device so as to collect energy generated by the energy generating device.

### FIELD OF THE INVENTION

The present invention relates to an energy generating mechanism including two adjusting members for moving boxes on two ends of the lever to keep swinging the lever to generate energy which is collected by an energy collection device.

### BACKGROUND OF THE INVENTION

Energy is a limited source which is used in a mass scale and gradually, the limited energy on earth reaches a limited line that threatens the everyday life of human beings. Although wind power, solar power, hydro power and even the earth heat are developed to generate energy, the geographic conditions limits the use of the energy. It is a beginning stage for using the nature power and we have a long way to go before the nature power can be dominated by human beings.

The present invention intends to provide an energy generating mechanism that includes a lever with two adjustable boxes on two ends of the lever so that the lever is kept swinging continuously by controlling the positions of the boxes and energy is generated by the movement of the lever and collected by an energy collection device.

### SUMMARY OF THE INVENTION

The present invention relates to an energy generating mechanism which comprises an energy generating device having a solid frame and a lever is connected to the solid frame. Two cases are respectively connected to two ends of the lever and each of the two cases has respective one of two boxes. Two acceleration devices are respectively connected to the two boxes so as to accelerate speed of swinging of the lever. Each of the two boxes has an adjusting member at one side thereof and the adjusting members change the arm of force of the lever to move the lever. An energy collection device is connected to the energy generating device so as to collect energy generated by the energy generating device.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the energy generating mechanism of the present invention while the energy generating mechanism is not yet activated;

FIG. 2 shows the left end of the lever in the energy generating mechanism of the present invention is in lower position when the energy generating mechanism is activated;

FIG. 3 shows the lever in the energy generating mechanism of the present invention is in horizontal position when the energy generating mechanism is activated;

FIG. 4 shows the left end of the lever in the energy generating mechanism of the present invention is in lower position when the energy generating mechanism is activated;

FIG. 5 shows the energy collection device of the present invention;

FIG. 6 shows that when the energy generating mechanism is activated, the right end of the lever is lowered;

FIG. 7 shows another status of the energy collection device of the present invention;

FIG. 8 shows the right end of the lever in the energy generating mechanism of the present invention is in lower position when the energy generating mechanism is activated;

FIG. 9 shows the boxes have weights and no resilient members are connected therewith;

FIG. 10 shows that the boxes are connected with the resilient members and no weights;

FIG. 11 shows that the energy generating mechanism is in an upright orientation, and

FIG. 12 shows another embodiment of the energy generating mechanism in an upright orientation.

### DETAILED DESCRIPTION OF THE PREFERRED EMBODIMENT

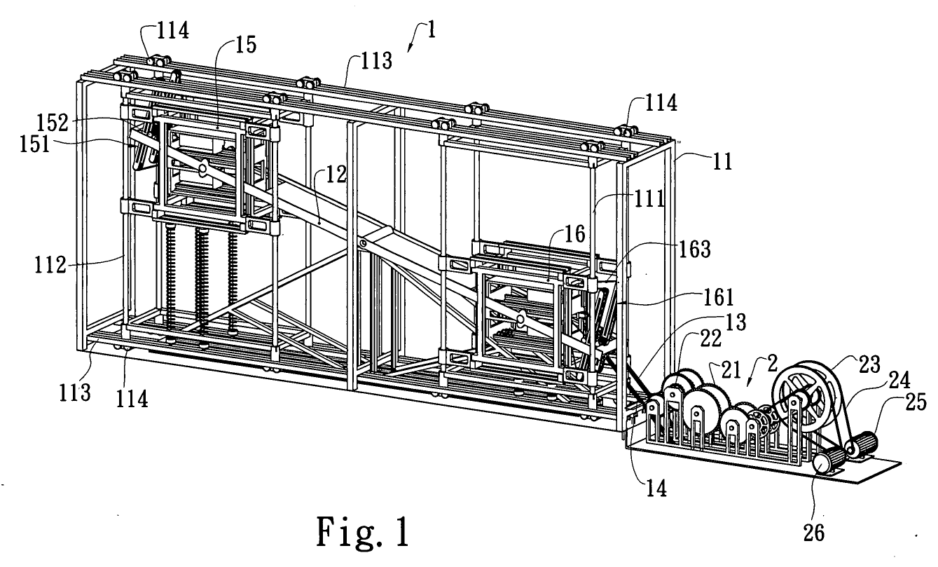

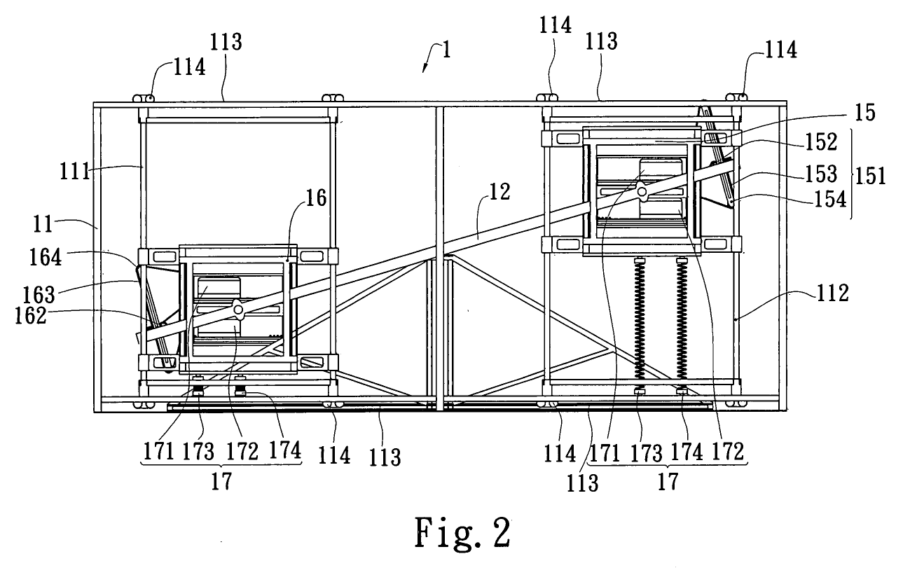

Referring to FIGS. 1 to 2, the energy generating mechanism of the present invention comprises an energy generating device 1 which has a solid frame 11 and a lever 12 connected to the solid frame 11. The lever 12 is supported at a fulcrum at a middle portion thereof so that two ends of the lever 12 are able to be moved about the fulcrum. Two output racks 13, 14 are connected to an end of the lever 12 so as to be connected with an energy collection device 2 which is composed of a plurality of gears 21, ratchets 22, flywheels 23, belts 24 and two energy collectors 25, 26. The two output racks 13, 14 are operated and moved by the swinging of the lever 12 so as to output energy to the energy collection device 2.

Two cases 111, 112 are respectively connected to two ends of the lever 12 and the solid frame 11 includes rails 113 on a top and a bottom thereof. Wheels 114 are connected to the cases 111, 112 and movably engaged with the rails 113. Each of the two cases 111, 112 has respective one of two boxes 15, 16 connected thereto and an adjusting member 151/161 is located at one side of the respective one of the two boxes 15, 16. The adjusting members 151, 161 are connected to a remote end from a fulcrum of the lever 12 of the boxes 15, 16. Each of the adjusting members 151, 161 includes a motor 152/162, cables 153/163 and pulleys 154/164. The cables 153, 163 are operated by the motors 152, 162 so that the cables 153/163 are tightened when the box 15/16 is located at high position, and are loosened when the box 15/16 is located at low position. Also, the boxes 15, 16 are kept horizontally by the cables 153, 163 during operation. The adjusting members 151, 161 change an arm of force of the lever 12 to move the lever 12 so that the two ends of the lever 12 are alternatively moved up and down by changing the arms of force. Two acceleration devices 17 are respectively connected to the two boxes 15, 16 so as to accelerate speed of swinging of the lever 12. In this embodiment, the acceleration devices 17 include two weights 171, 172 received in each of the two boxes 15, 16 and/or resilient members 173, 174 connected between the two respective sides of the two boxes 15, 16 and the cases 111, 112. The resilient members 173, 174 can be springs.

As shown in FIG. 2, before the mechanism is activated, the box 15 at the right end of the lever 12 is located at an upper position and the box 16 at the left end of the lever 12 is located at a lower position. The weights 171, 172 are located symmetrically in the box 15 and at the outer most positions in the boxes 15, 16 from the fulcrum of the lever 12. The cable 153 of the adjusting member 15 and the cable 163 of the adjusting member 16 are both in tension status.

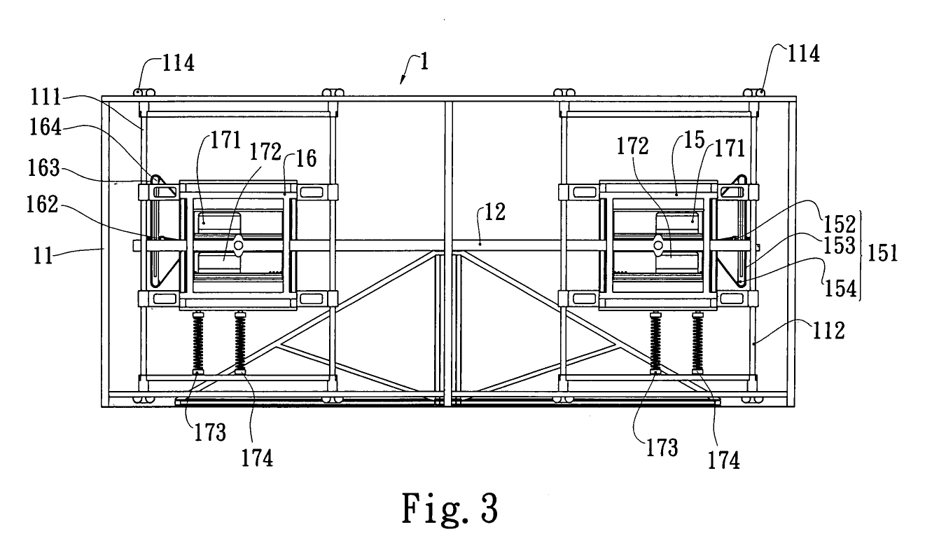

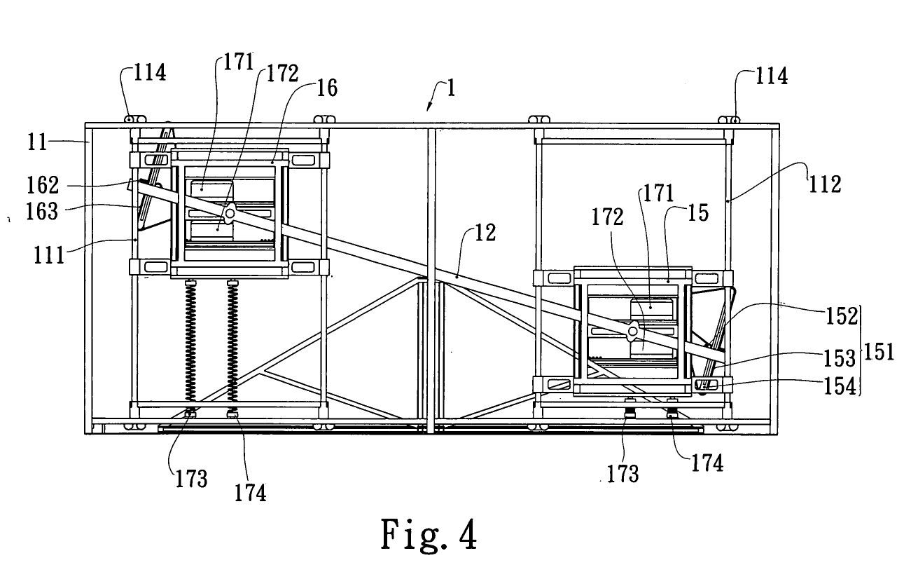

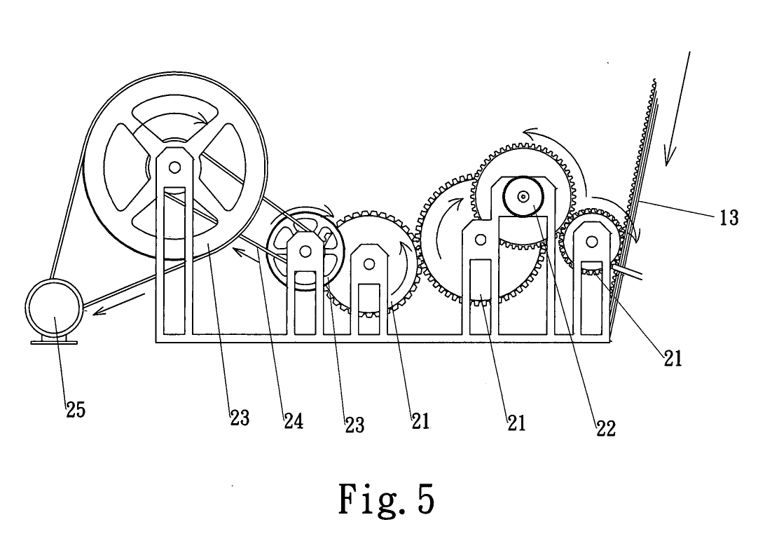

As shown in FIGS. 2 to 5, when the mechanism is activated, the motor 162 loosens the cable 163 so that the center of mass of the box 16 moves toward the fulcrum and the box 15 is lowered. By the weights 171, 172 and resilient members 173, 174, the box 15 is lowered rapidly in the case 112 till the box 15 is located at the lowest position and the box 16 is located at the upper most position. The resilient members 173, 174 of the box 15 are compressed and the resilient members 173, 174 of the box 16 are extended. The cable 163 of the adjusting member 161 are loosened and the cable 153 of the adjusting member 151 are in tension as shown in FIG. 4.

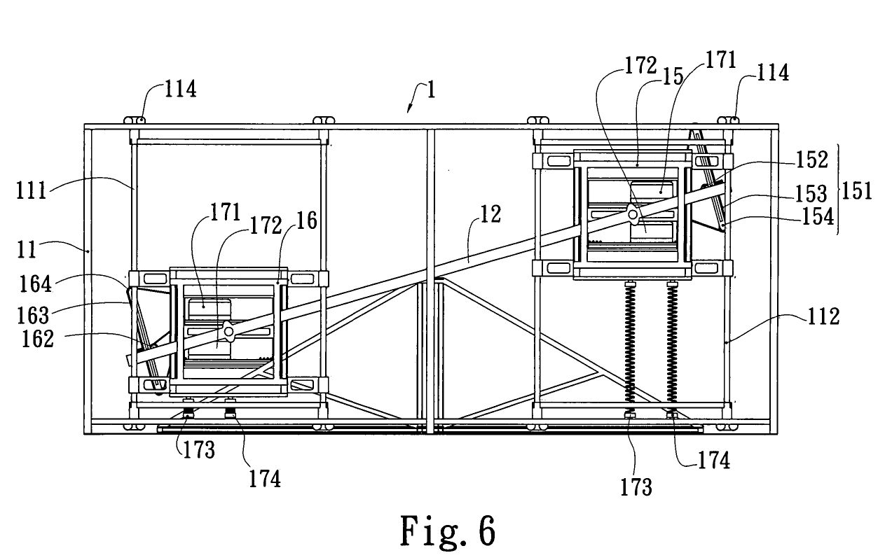

The motor 162 is activated immediately when the mechanism is in the status as shown in FIG. 4, the cable 163 of the adjusting member 161 is loosened slowly by cooperation with the pulleys 164. In the same time, the motor 152 is activated and the cable 153 of the adjusting member 151 is loosened. The center of mass of the box 15 moves toward the fulcrum and the box 16 is lowered. By the weights 171, 172 and resilient members 173, 174, the box 16 is lowered rapidly till the box 16 is located at the lowest position and the box 15 is located at the upper most position. The resilient members 173, 174 of the box 16 are compressed and the resilient members 173, 174 of the box 15 are extended. The cable 153 of the adjusting member 151 are loosened and the cable 163 of the adjusting member 161 are in tension as shown in FIG. 6.

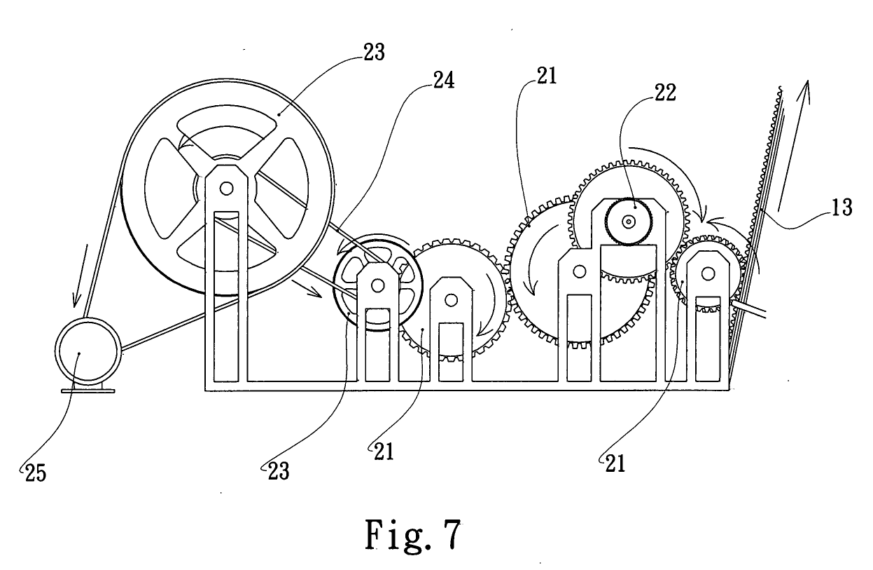

As shown in FIG. 7, when the left end of the lever 12 is raised, the output racks 13, 14 are pulled upward, the energy generated by the mechanism is transferred to the energy collectors 26 via the gears 21, clutches, ratchets 22, flywheels 23 and belts 24.

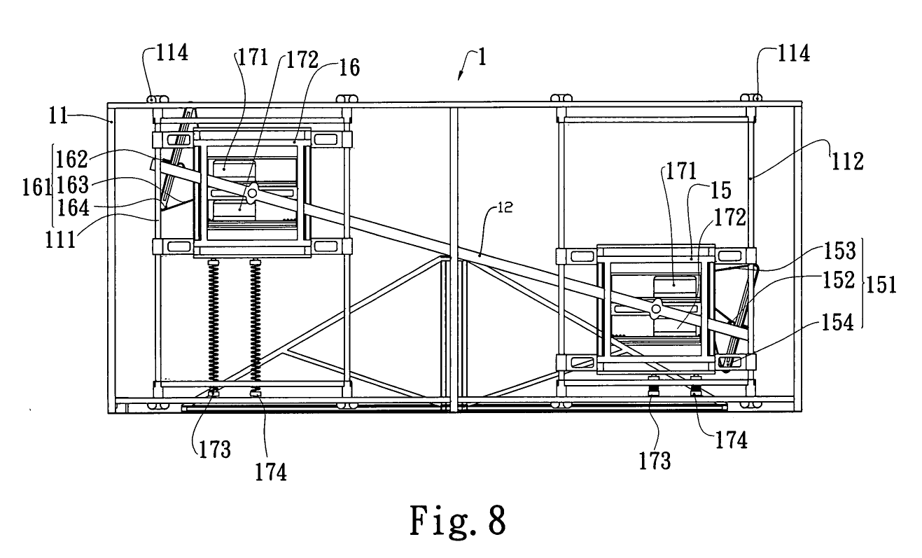

As shown in FIGS. 6 and 8, when the box 16 is located at the lowest position, the motor 162 is activated to loosen the cable 163 of the adjusting member 161. The motor 152 of the box 15 at the upper most position is activated to pull the cable 153 so that the box 16 is raised and the box 15 is lowered again. The resilient members 173, 174 of the box 15 are compressed and the resilient members 173, 174 of the box 16 are extended. By the operation of the cables 153 and 163, the boxes 15 and 16 can be maintained horizontally.

The motors 152, 162 on two ends of the lever 12 control the cables 151 and 161 to control the boxes 15 and 16 moves up and down in a horizontal orientation. The weights 171, 172 of the boxes 15, 16 and the resilient members 173, 174 accelerate the movement of the lever 12 to effectively generate energy.

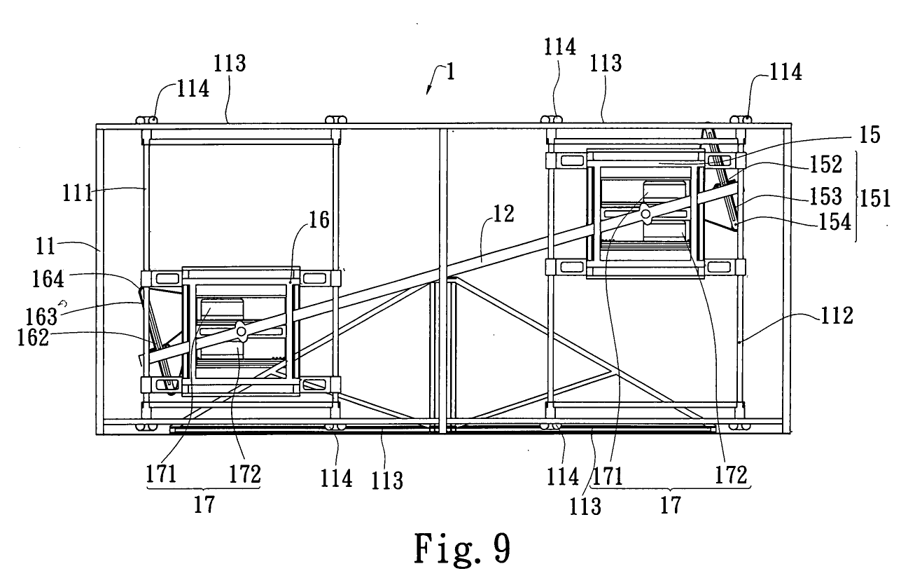

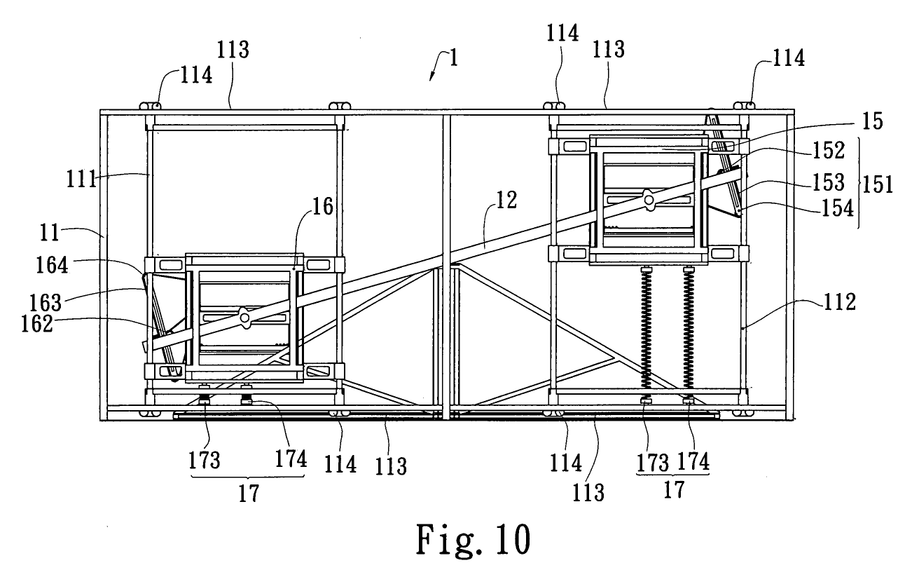

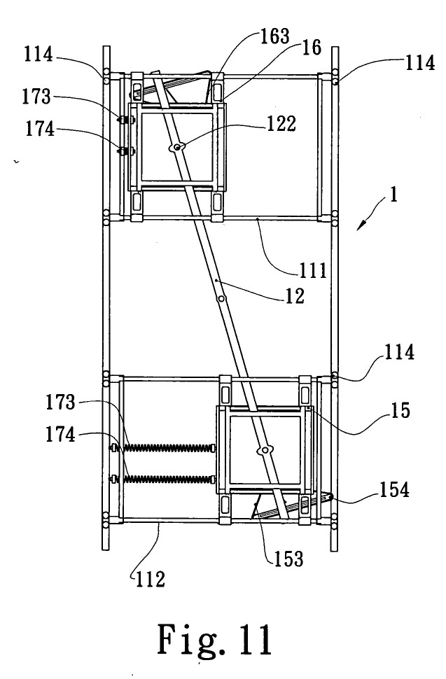

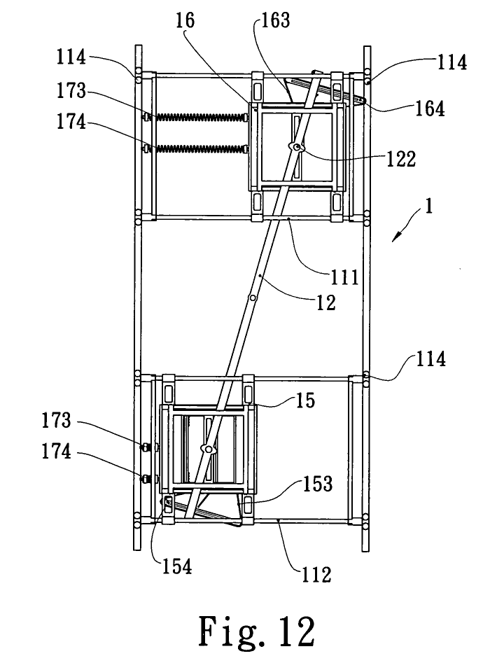

Besides, the weights 171, 172 and the resilient members 173, 174 can also be set as shown in FIGS. 9 and 10. The mechanism 1 can be made to be upright as shown in FIGS. 11 and 12 or any other angular orientation so as to meet requirements of different cites.

While we have shown and described the embodiment in accordance with the present invention, it should be clear to those skilled in the art that further embodiments may be made without departing from the scope of the present invention.

What is claimed is:

1. An energy generating mechanism comprising:
an energy generating device having a solid frame and a lever with a fulcrum connected to the solid frame, two cases respectively connected to two ends of the lever, each of the two cases having respective one of two boxes two acceleration devices respectively connected to the two boxes so as to accelerate speed of swinging of the lever, each of the two boxes having an adjusting member at one side thereof and the adjusting members changing an arm of force of the lever to move the lever, and
an energy collection device connected to the energy generating device so as to collect energy generated by the energy generating device.

2. The mechanism as claimed in claim 1, wherein the energy collection device includes a plurality of gears, ratchets, flywheels, belts and two energy collectors via them energy generated by the energy generating device is transferred to the energy collectors.

3. The mechanism as claimed in claim 1, wherein two output racks are connected to an end of the lever so as to be connected with the energy collection device, the two output racks are operated by the swinging of the lever.

4. The mechanism as claimed in claim 1, wherein the acceleration devices two weights are received in each of the two boxes.

5. The mechanism as claimed in claim 1, wherein the acceleration devices includes resilient members connected between the two respective sides of the two boxes and the cases.

6. The mechanism as claimed in claim 1, wherein the acceleration devices includes resilient members and two weights in the two boxes, the resilient members are connected between the two respective sides of the two boxes and the cases.

7. The mechanism as claimed in claim 5, wherein the resilient members are springs.

8. The mechanism as claimed in claim 6, wherein the resilient members are springs.

9. The mechanism as claimed in claim 1, wherein the adjusting members are connected to a remote end from a fulcrum of the lever of the boxes, each of the adjusting members including a motor, cables and pulleys, the cables are operated by the motors, the cables are tightened when the box is located at high position, and are loosened when the box is located at low position, the boxes are kept horizontally by the cables.

10. The mechanism as claimed in claim 1, wherein the solid frame includes rails on a top and a bottom thereof and wheels are connected to the cases to being movably engaged with the rails.
